(19) United States
(12) Patent Application Publication
(10) Pub. No.: US 2010/0301174 A1
(43) Pub. Date: Dec. 2, 2010

(54) SYSTEM FOR CONTROLLING AT LEAST ONE AIRCRAFT ENGINE AND AN AIRCRAFT COMPRISING SUCH A CONTROL SYSTEM

(75) Inventors: Brice Fernandez, Toulouse (FR); Vincent Lamonzie, Toulouse (FR)

Correspondence Address: J. Rodman Steele;Novak Druce & Quigg LLP, 525 Okeechobee Blvd, Suite 1500, West Palm Beach, FL, 33401, US

(73) Assignee: AIRBUS OPERATIONS (SAS), TOULOUSE (FR)

(21) Appl. No.: 12/787,272

(22) Filed: May 25, 2010

(30) Foreign Application Priority Data
May 29, 2009 (FR) 0902597

(51) Int. Cl. B64D 31/06

(52) U.S. Cl. 244/234

(57) ABSTRACT

A system for controlling at least one aircraft engine and an aircraft comprising such a control system. The system (4) comprises a control lever (5) of the engine, the intermediary range of automatic regulation thereof of the engine speed of which comprises a single marked position (II) with which there is associated a plurality of speeds, corresponding to each one of the flight phases of the aircraft (AC) such as take-off and climbing phases.

### CROSS-REFERENCE TO RELATED APPLICATIONS

This application claims priority to French Patent Application 0902597, filed May 29, 2009, the contents of which are incorporated herein by reference.

### FIELD OF THE INVENTION

The present invention relates to a system for controlling at least one aircraft engine, as well as an aircraft comprising such a control system.

### BACKGROUND OF THE INVENTION

It is known that, in a large number of aircrafts, including those for civil transport, the engine speeds are controlled individually, during a flight (comprising take-off, climbing, cruising, descent and approach phases), by throttle control levers, respectively associated with said engines. Such control levers are able to occupy a position amongst a plurality of positions, including:
an idling or idle position;
a first marked climbing position;
a second marked climbing position, allowing to obtain either a maximum continuous thrust (MCT) speed at the output of the corresponding engine, when at least one of the engines of such an aircraft breaks down, or a FLEX TO (<<Flexible take-off>>) speed allowing to perform a take-off with a reduced thrust. For performing such a take-off at a FLEX TO speed, the pilot should preliminarily configure specific parameters of said speed. In the absence of configuration of the latter, the MCT speed is applied by default to the corresponding engine upon take-off; and
a marked take-off and go-around position corresponding to a speed delivering a maximum take-off or go-around thrust at the output of the engines.

Moreover, each control lever could occupy an auto-thrust (A/THR) intermediary range of automatic regulation in the corresponding engine speed, by a automatic pilot of the aircraft. Such an intermediary range extends from the idle position to the first climbing position.

However, it can happen that the pilot, wishing to take off in a FLEX TO derated take-off speed, positions the control levers in the second climbing position, but forgets to configure the parameters associated with such a FLEX TO speed. In such a case, the MCT speed is applied by default to the engines upon take-off, what can surprise the pilot (thinking he is taking off at a FLEX TO speed) and lead to take inappropriate actions on the levers with a view to correcting his mistake.

Moreover, should one of the engines of the aircraft break down upon a FLEX TO take-off (the control levers occupy the second climbing position), the pilot should position the control levers in the take-off and go-around position, then position them in the second climbing position, for selecting the MCT speed. Whereas the pilot is already to manage the engine break down, such a reciprocating movement of the control levers, not intuitive for the pilot, is likely to further disturb him.

### SUMMARY OF THE INVENTION

The aim of the present invention is to overcome such drawbacks, and, more particularly to make the handling and the use of the control levers of the engines more intuitive for the pilot of the aircraft.

To this end, according to this invention, the system for controlling at least one aircraft engine using a specific moving control lever, said control lever being able to occupy two extreme positions corresponding to the idle speed and to the maximum speed of said engine, as well as an intermediary range of automatic regulation of the speed of said motor, the lower limit of said intermediary range being defined by the extreme position corresponding to the idle speed, is characterized in that:
said intermediary range comprises a single marked position, corresponding to the upper limit thereof;
a plurality of speeds of said engine, corresponding to each one of the flight phases of said aircraft such as take-off and climbing phases, is associated with said marked position of the intermediary range; and
said system comprises:
   means for determining the usual flight phase of said aircraft; and
   means for automatically controlling the speeds of said engine associated with said marked position of the intermediary range, from information received from said determining means.

Thus, according to this invention, there can be used, during a flight of the aircraft (i.e. upon the take-off, climbing, cruising, descent and approach phases) a single position, i.e. the marked position of the intermediary range. Handling the control lever is then very intuitive and the risk of an inappropriate use is considerably reduced. Moreover, the pilot's work load is significantly reduced during the flight of the aircraft.

Moreover, the control lever can be brought by the pilot in the extreme position corresponding to the maximum speed, allowing to get the aircraft out of a possible critical situation bringing a maximum thrust at the output of the corresponding engine.

Said plurality of speeds of said engine associated with said marked position of the intermediary phase can be determined either automatically or manually by the pilot, an automatic determination reducing the pilot's work load.

Advantageously, said automatic control means can automatically manage the speed transitions between said successive flight phases of said aircraft.

In addition, said automatic control means can automatically manage the speed transitions within a single flight phase of said aircraft.

Obviously, this invention further relates to a control lever for an aircraft engine belonging to a control system such as previously described and able to occupy two extreme positions, corresponding to the idle speed and to the maximum speed of said engine, as well as an intermediary range of automatic regulation of the speed of said engine, the lower limit of said intermediary range being defined by the extreme position corresponding to the idle speed.

According to this invention, said intermediary range comprises a single marked position, corresponding to the upper limit thereof, and with which there is associated a plurality of speeds of said engine, corresponding to each one of the flight phases of said aircraft, such as take-off and climbing phases.

Additionally, the present invention also relates to an aircraft comprising at least a control system such as previously described.

### BRIEF DESCRIPTION OF THE DRAWINGS

The figures of the appended drawing will better explain how this invention can be implemented. On the figures, identical reference numerals relate to similar components.

FIG. 1 schematically shows from the top a two-engine airplane as well as the block diagram of each one of the control systems of the two engines of the airplane. For clarity reasons of the drawing, such control systems are illustrated outside said airplane.

FIG. 2 is a profiled schematic view of one of the moving control levers shown on FIG. 1.

FIG. 3 is a graph representing the different speeds being available for an engine of the airplane as a function of the corresponding position of the control lever, according to the present invention.

### DETAILED DESCRIPTION

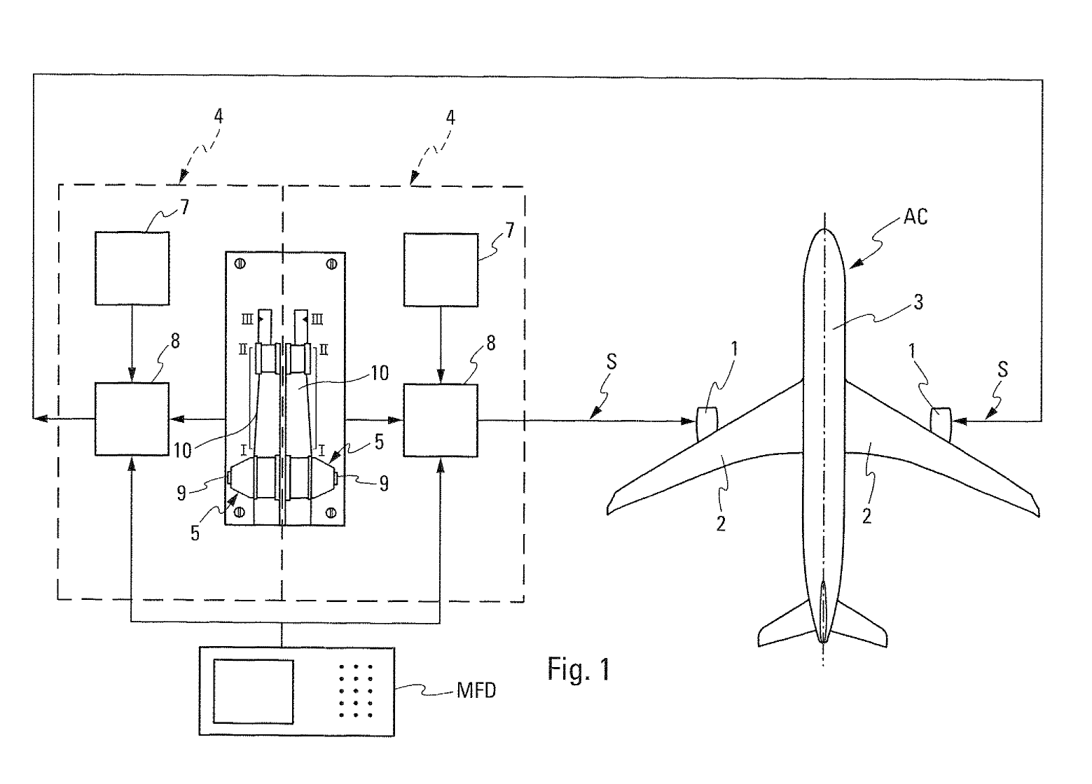

On FIG. 1, there is represented, in a top view, an airplane AC comprising two engines 1 supported on each one of the two wings 2 thereof, symmetrically with respect to the fuselage 33.

As shown on FIG. 1, the speed of each engine 1 of the airplane AC can be controlled through a control system 4, according to the present invention, by means of a specific moving control lever 5.

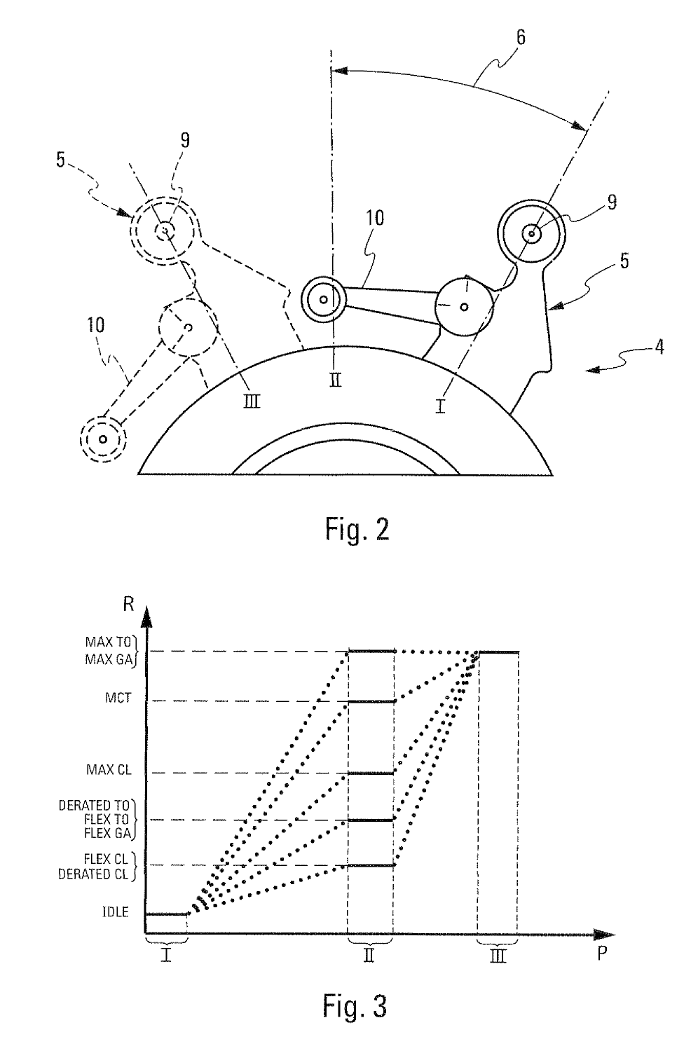

Each control lever 5 can occupy two extreme positions corresponding to the idle speed (designated with I on FIGS. 1 and 2) and to the maximum speed (designated with III on said figures) of the corresponding engine 1, as well as an A/THR intermediary range of automatic regulation of the speed of said engine 1 (symbolized by the arrow 6 on FIG. 2).

For each control lever 5, the extreme position of idle speed I is for instance used upon starting the corresponding engine 1, preliminarily to implementing the thrust inversion mode, upon landing, etc. It could be materialized by a fixed stop.

In addition, according to this invention, the maximum speed position III of each lever 5 could be materialized by a hard point of the catch type. Thus, the maximum speed of an engine 1 is reached when the control lever 5 is brought on such a hard point (the control lever 5 is illustrated in such a position in dashed lines on FIG. 2). The pilot of the airplane can more specifically position each control lever 5 in such a position III when he wishes to obtain at the output of the corresponding engine the maximum available thrust (for example, upon a take-off initially programmed with a reduced thrust, or for a go-around, or even when he wishes to manually take off with a maximum thrust without automatic transition of the speed from the take-off phase to the climbing phase as detailed herein after).

In addition, the intermediary range 6 of each control lever 5 comprises a single marked position (designated with II on FIGS. 1 and 2), corresponding to the higher limit thereof. Such a single marked position II is, for instance, materialized by a hard point of the catch type. The lower limit of the intermediary range 6 is, as far as it is concerned, defined by the extreme position I, corresponding to the idle speed.

As shown on FIGS. 1 and 2, the positions I, II and III are respectively adjacent two by two. Thus, for bringing the control lever 5 in the position III from the position I, said control lever 5 goes necessarily through the position

According to this invention, a plurality of engine speeds, corresponding to at least some of the flight phases of the airplane AC, can be associated, either automatically or manually, by an action from the pilot, to the marked position II of the intermediary range 6 of each control lever 5.

Each control system 4 further comprises:
means 7 for determining the flight usual phase of the airplane AC (for example, take-off, climbing, etc.). Of course, the means 7 could be common to both control systems 4; and
means 8 for automatically controlling the speeds associated with said marked position II of the intermediary range 6, said means being linked to the corresponding control lever 5 and to the determining means 7. From information received from said determining means 7 and from the position of the corresponding control lever 5, the automatic control means 8 are able to deliver, at the output, a control signal S for the engine speed 1 associated therewith. It should be noticed that such automatic control means 8 can be integrated into an EEC electronic calculator (for <<Electronic Engine Control>>) associated with the corresponding engine 1.

Usually, as shown on FIGS. 1 and 2, each control lever 5 comprises:
a button 9 for manually deactivating the A/THR automatic regulation of the engine speed, able to be actuated by the pilot when he wishes to disengage such an automatic regulation mode; and
a lever 10 for controlling the thrust inversion mode of the corresponding engine 1, able to be toggled by the pilot in order to activate and adjust the thrust inversion.

According to this invention, preliminarily to each take-off, the pilot can configure the take-off speed, associated with the marked position II of each control lever 5, so that it is automatically applied upon take-off. The configuration of such a take-off speed could be performed for instance by means of a MFD (for <<Multi-Function Display>>) managing multi-function interface. For this, the pilot can select, first of all, the take-off speed amongst the three following speeds:
a first FLEX TO derated take-off speed;
a second DERATED TO (for <<Derated take-off>>) derated take-off speed; and
a MAX TO (for <<Maximum take-off>>) derated take-off speed.

Then, when a take-off speed has been selected, the pilot configures the parameters associated with such a selected speed via the MED managing interface.

By default, when no take-off speed has been configured by the pilot, the MAX TO maximum thrust take-off speed can be applied upon the airplane AC taking off.

Obviously, alternately, the configuration of the take-off phase can be performed automatically, for instance, through the automatic control means 8.

In addition, on the ground, or in flight, the pilot can also configure (for example, using the MFD managing interface), a climbing speed associated with the marked position II of each control lever 5. Such a climbing speed corresponds to the speed automatically applied to the corresponding engine 1 by the automatic control means 8 upon the climbing phase (following the take-off phase).

For this, the pilot can first of all select the climbing speed for instance, amongst the three following speeds:
a first FLEX CL (for <<Flexible Climb>>) reduced thrust climbing speed:
a second DERATED CL (for <<Derated Climb>>) reduced thrust climbing speed; and
a MAX CL (for <<Maximum Climb>) maximum thrust climbing speed.

When no configuration of the climbing phase has been carried out by the pilot, the MAX CL speed can be applied by default upon the climbing phase.

Obviously, alternatively, the configuration of climbing phase can be performed automatically, for instance, using the automatic control means 8.

Additionally, for each engine 1 of the airplane AC, the speed transition from the take-off phase to the climbing phase (the corresponding control lever 5 remaining in the position II) is automatically implemented by the automatic control means 8, as soon as one transition condition is met. Such transition condition could correspond either:
to the airplane AC exceeding a predefined threshold altitude;
to the flaps being retracted from the wings 2;
etc.

Moreover, in the marked position II, switching from the climbing phase to the A/THR automatic regulation phase of the speed of the engines 1 (when such an A/THR automatic regulation is engaged), is also automatically carried out as soon as one activation condition is validated (for example, when a predefined altitude is exceeded).

Moreover, for maintaining the take-off thrust at the output of the engines 1 of the airplane AC after the take-off phase has been completed, the pilot can, for instance, bring the control levers 5 of the two engines in the position III from the position II or even position them in an intermediary position, between the position II and the position III. In such a case, the automatic transition from the take-off phase to the climbing phase is, for example, only implemented once the control levers 5 have returned to the position II.

Moreover, after take-off, the pilot can also order a FLEX GA (for <<Flexible Go Around>>) reduced thrust go-around to the engines 1 of the airplane AC, shifting the corresponding control levers 5 from the position II to the position III, then returning them to the position IL Such a handling engages the FLEX GA reduced thrust go-around speed (the configuration of said speed being carried out either before take-off, or in flight, either manually or automatically).

In addition, upon the climbing phase after take-off, should the speed of one of the engines 1 of the airplane AC be idle (for example, as a result of a voluntary action from the pilot on the corresponding control lever 5, or as a result of said engine 1 breaking down), a MCT continuous maximum thrust climbing speed can be applied to the other valid engine 1. Such a MCT speed is selected, either automatically or manually by the pilot through the MFD managing interface. The transition from the configured climbing speed (for example MAX CL) to the MCT climbing speed is carried out automatically by the automatic control means 8.

Furthermore, upon a take-off, one of the engines 1 of the airplane can meet problems (for instance a high temperature of burnt gases, strong vibrations, a defective fuel supply controller, etc . . . ), requiring the speed being applied to it to be reduced. Also, the pilot can shift the corresponding control lever 5 so as to bring it from the marked position II to an intermediary position between the marked position II and the idle position I. The speed of the engine 1 being considered is then reduced with respect to that applied when the control lever 5 occupied the position II.

Furthermore, should one of the engines 1 of the airplane AC break down upon a take-off, the pilot may decide:
either to keep the speed of the valid engine 1 such as preliminarily configured. The transition from the take-off phase to the climbing phase can then be either automatic, when said transition condition is met, or manual. In this latter case, the pilot should shift at least the control lever 5 of the valid engine 1 in the position III, then return it in the position H for activating said transition. In the absence of such a handling, the take-off thrust is maintained;
or to increase the speed of the valid engine 1 of the airplane AC bringing at least the corresponding control lever 5 in a position higher than the position IL In such a case, the automatic transition from the take-off phase to the climbing phase is, for example, implemented when at least the control lever 5 corresponding to the valid engine 1 is returned in the position H, with the condition that said above mentioned transition condition is met.

Moreover, when one of the engines 1 of the airplane AC breaks down in flight after a take-off (the control levers 5 occupying the position II), the MCT continuous maximum thrust speed can be selected so as to be applied to the remaining valid engine 1. Such a selection is performed either automatically or manually by the pilot, for example, by means of the MFD managing interface.

On FIG. 3, there are represented the speeds R of an engine 1 of the airplane AC as a function of the position of the corresponding control lever 5. Thus, as previously described, several distinct speeds (corresponding to each one of the flight phases of the airplane AC) can be associated with the marked position II, the transitions between such different speeds being managed automatically by the automatic control means 8.

1. A system for controlling at least one engine (1) of an aircraft (AC) by means of a specific moving control lever (5), comprising:
a control lever (5) being able to occupy two extreme positions (I, III) corresponding to the idle speed (1) and to the maximum speed (III) of said engine (1), as well as an intermediary range of automatic regulation of the speed of said engine (1), the lower limit of said intermediary range being defined by the extreme position (I) corresponding to the idle speed, wherein:
said intermediary range (6) comprises a single marked position (II), corresponding to the upper limit thereof;
a plurality of speeds of said engine (1), corresponding to each one of the flight phases of said aircraft (AC), such as the take-off and climbing phases, is associated with said marked position (II) of the intermediary range (6); and
said system (4)comprising:
means (7) for determining the usual flight phase of said aircraft (AC); and
means (8) for automatically controlling speeds of said engine (1) associated with said marked position (H) of the intermediary range (6), from information received from said determination means (7).

2. A system according to claim 1, wherein said plurality of speeds of said engine (1) associated with said marked position (II) of the intermediary range (6) is automatically determined.

3. A system according to claim 1, wherein said plurality of speeds of said engine (1) associated with said marked position (11) of the intermediary range (6) is manually determined by the pilot.

4. A system according to claim 1, wherein said automatic control means (8) automatically manage the speed transitions between said successive flight phases of said aircraft (AC).

5. A system according to claim 1, wherein said automatic control means (8) automatically manage the speed transitions within one single phase of said aircraft (AC).

6. A control lever of an engine (1) of an aircraft (AC) belonging to a control system according to claim 1, said control lever (5) being able to occupy two extreme positions (1, III) corresponding to the idle speed (I) and to the maximum speed (III) of said engine (1), as well as an intermediary range of automatic regulation of the speed of said engine (1), the lower limit of said intermediary range being defined by the extreme position (I) corresponding to the idle speed,
wherein said intermediary range (6) comprises a single marked position (II), corresponding to the upper limit thereof and with which there is associated a plurality of speeds of said engine (1), corresponding to each one of the flight phases of said aircraft (AC) such as the take-off and climbing phases.

7. An aircraft, comprising at least one control system (4) according to claim 1.
